(19) United States
(12) Patent Application Publication
(10) Pub. No.: US 2025/0374046 A1
(43) Pub. Date: Dec. 4, 2025

(54) INFORMATION REPORTING METHOD AND APPARATUS, TERMINAL, AND READABLE STORAGE MEDIUM

(71) Applicant: VIVO MOBILE COMMUNICATION CO., LTD., Dongguan (CN)

(72) Inventors: Ranran HE, Dongguan (CN); Wei BAO, Dongguan (CN)

(21) Appl. No.: 19/299,382

(22) Filed: Aug. 14, 2025

Related U.S. Application Data
(63) Continuation of application No. PCT/CN2024/076417, filed on Feb. 6, 2024.

(30) Foreign Application Priority Data
Feb. 14, 2023 (CN) 202310124060.3

(51) Int. Cl. H04W 12/06; H04W 12/0431; H04W 36/08; H04W 76/20

(52) U.S. Cl. CPC H04W 12/06; H04W 12/0431; H04W 36/08; H04W 76/20

(57) ABSTRACT

Provided are an information reporting method and apparatus, a terminal, and a non- transitory readable storage medium. The information reporting method includes following operations. A terminal performs signature verification on at least one first cell. The terminal reports signature verification result-related information to a network side device.

### CROSS-REFERENCE TO RELATED APPLICATIONS

This application is a continuation of International Patent Application No. PCT/CN2024/076417, filed on February 06, 2024, which claims priority to Chinese Patent Application No. 202310124060.3, filed in China on February 14, 2023, both of which are incorporated herein by reference in their entireties.

### TECHNICAL FIELD

This application relates to the field of communication technologies, and in particular, to an information reporting method and apparatus, a terminal, and a readable storage medium.

### BACKGROUND

Currently, a terminal may verify authenticity of a broadcast message by verifying signature information, so as to avoid camping on a cell deployed on a fake base station.

In the related art, a network side device sends System Information (SI), a Signature Key (K-SIG), information related to a sending time of the SI, and the like to a terminal. The terminal performs signature verification by using the information as parameters, to finally obtain a Digital Signature (DS) corresponding to the SI. Therefore, the terminal may determine whether the digital signature corresponding to the SI matches a digital signature corresponding to the SI broadcast by the network side device, to verify authenticity of the SI, and then determine whether to establish a connection to a base station corresponding to the SI.

### SUMMARY

Embodiments of this application provide an information reporting method and apparatus, a terminal, and a readable storage medium.

According to a first aspect, an information reporting method is provided, performed by a terminal. The method includes: A terminal performs signature verification on at least one first cell. The terminal reports signature verification result-related information to a network side device.

According to a second aspect, an information reporting apparatus is provided, including an execution module and a transmission module. The execution module is configured to perform signature verification on at least one first cell. The transmission module is configured to report signature verification result-related information to a network side device.

According to a third aspect, a terminal is provided. The terminal includes a processor and a memory. The memory stores a program or instructions executable in the processor. The program or the instructions, when executed by the processor, implement the steps of the method described in the first aspect.

According to a fourth aspect, a terminal is provided, including a processor and a communication interface. The processor is configured to perform signature verification on at least one first cell. The communication interface is configured to report signature verification result-related information to a network side device.

According to a fifth aspect, a readable storage medium is provided. The readable storage medium stores a program or instructions. The program or the instructions, when executed by a processor, implement the steps of the method described in the first aspect.

According to a sixth aspect, a chip is provided. The chip includes a processor and a communication interface. The communication interface is coupled to the processor. The processor is configured to run a program or instructions to implement the method described in the first aspect.

According to a seventh aspect, a computer program/program product is provided. The computer program/program product is stored in a storage medium. The program/program product is executed by at least one processor, to implement the steps of the information reporting method described in the first aspect.

### BRIEF DESCRIPTION OF THE DRAWINGS

FIG. 1 is a possible schematic structural diagram of a communication system involved in an embodiment of this application;

FIG. 2 is a schematic flowchart of an information reporting method according to an embodiment of this application;

FIG. 3 is a schematic structural diagram I of an information reporting apparatus according to an embodiment of this application;

FIG. 4 is a schematic structural diagram II of an information reporting apparatus according to an embodiment of this application;

FIG. 5 is a schematic structural diagram III of an information reporting apparatus according to an embodiment of this application;

FIG. 6 is a schematic diagram of a hardware structure of a communication device according to an embodiment of this application; and

FIG. 7 is a schematic diagram of a hardware structure of a terminal according to an embodiment of this application.

### DETAILED DESCRIPTION

Technical solutions in embodiments of this application are clearly described below with reference to drawings in embodiments of this application. Apparently, the described embodiments are merely some rather than all embodiments of this application. All other embodiments obtained by a person of ordinary skill in the art based on embodiments of this application fall within the protection scope of this application.

Terms "first", "second", and the like in this application are used to distinguish between similar objects rather than describe a specific order or sequence. It should be understood that the terms used in this way may be transposed where appropriate, so that embodiments of this application may be implemented in a sequence other than those illustrated or described herein. In addition, objects defined by "first" and "second" are generally of the same class and do not limit a quantity of objects. For example, one or more first objects may be arranged. In addition, "or" in this application indicates at least one of connected objects. For example, "A or B" encompasses three solutions: solution I: A is included but B is not included; solution II: B is included but A is not included; and solution III: both A and B are included. A character "/" generally indicates an "or" relationship between associated objects.

A term "indication" in this application may be a direct indication (or an explicit indication) or an indirect indication (or an implicit indication). A direct indication may be understood as that a sending party clearly tells a receiving party specific information, an operation to be performed, or a request result in the indication that is sent, and an indirect indication may be understood as that a receiving party determines corresponding information based on an indication sent by a sending party, or makes a judgment and determines an operation to be performed or a request result based on a judgment result.

Relevant terms involved in embodiments of this application are explained below:

1). System Information (SI)

SI includes a Master Information Block (MIB) and a series of System Information Blocks (SIB), and may be divided into Minimum System Information (Minimum SI) and other System Information (other SI):

(1) Minimum SI includes basic information required for initial access and content of other SI that is scheduled, including:

MIB: it includes cell bar status information and basic physical layer information of a cell required for further receiving system information; and

SIB1: it is a scheduling information block indicating whether a UE is allowed to connect to a cell and other SIBs.

(2) Other SIBs are SIBs other than Minimum SI, such as

SIB2: it is public information used for same-frequency, inter-frequency, or inter-system cell reselection by a User Equipment (UE) in an idle state or an inactive state;

SIB3: it is information dedicated for same-frequency cell reselection by an idle or inactive UE;

SIB4: it is information dedicated for inter-frequency cell reselection by an idle or inactive UE; and

SIB5: it is information dedicated for inter-system cell reselection by an idle or inactive UE.

(3) SIBs other than the SIB1: Each SIB has a particular sending period, for example, 80 ms, 160 ms, or 320 ms. The sending period of each SIB is configurable, which is notified to a terminal by a base station. A plurality of SIBs having a same sending period may form an SI message for sending.

(4) The SI message is sent in a predetermined sending window, and the SI message and the window are in one-to-one correspondence, that is, one SI message corresponds to one window, and only one SI message is sent in one window. Within a sending period, each SI message has a sending window. A UE receives an SI message in a corresponding window. A time length of a sending window of an SI message is configurable, but time lengths of all SI message windows in a cell are the same. Windows of different SI messages are connected end to end.

In a window, a base station may select one or more slots to send an SI message. In a window, a sent SI message may be combined through HARQ (that is, in a window, content of the SI message cannot be changed).

(5) A mapping relationship between other SIBs and an SI message is configured by the SIB1. The SIB1 further indicates a window time location of each SI message, that is, the UE needs to first obtain the SIB1 before obtaining the other SIBs.

2). Broadcast message security

In an existing network, a base station sends system information through broadcast. Content of the system information is sent in plaintext without security protection. If an illegal base station sends system information, instructing a terminal residing under the illegal base station to perform some operations (for example, reselection based on a designated priority of frequencies), the terminal will work based on the instruction of the illegal base station. This may cause a failure of a related policy configured by an operator. The UE may even be guided to connect to the illegal base station, causing an unpredictable loss to a user. To avoid this situation, a digital signature for the system information is required, so that the UE verifies legality of the base station. If the system information under protection of the digital signature changes, the corresponding digital signature also changes.

3). System information signature

Verification of a system message uses the following input parameters: SI, a Signature Key (K-SIG), information related to a sending time of the SI, and the like. An output result is a Digital Signature (DS) corresponding to the SI. The terminal determines whether the digital signature corresponding to the SI matches a digital signature corresponding to the SI broadcast by a network, to verify authenticity of the SI.

It should be noted that, technologies described in embodiments of this application may be applied to a Long Term Evolution (LTE)/Lte-Advanced (LTE-A) system, and may be further applied to another wireless communication system, such as a Code Division Multiple Access (CDMA) system, a Time Division Multiple Access (TDMA) system, a Frequency Division Multiple Access (FDMA) system, an Orthogonal Frequency Division Multiple Access (OFDMA) system, a Single-Carrier Frequency Division Multiple Access (SC-FDMA) system, or another system. Terms "system" and "network" in embodiments of this application are usually interchangeably used, and the described technologies may be used for both the system and the radio technologies mentioned above, as well as for another system and radio technology. A New Radio (NR) system is described below as an example, and the term NR is used in most of the following description. Nevertheless, the technologies may also be applied to a system other than the NR system, such as a 6th Generation (6G) communication system.

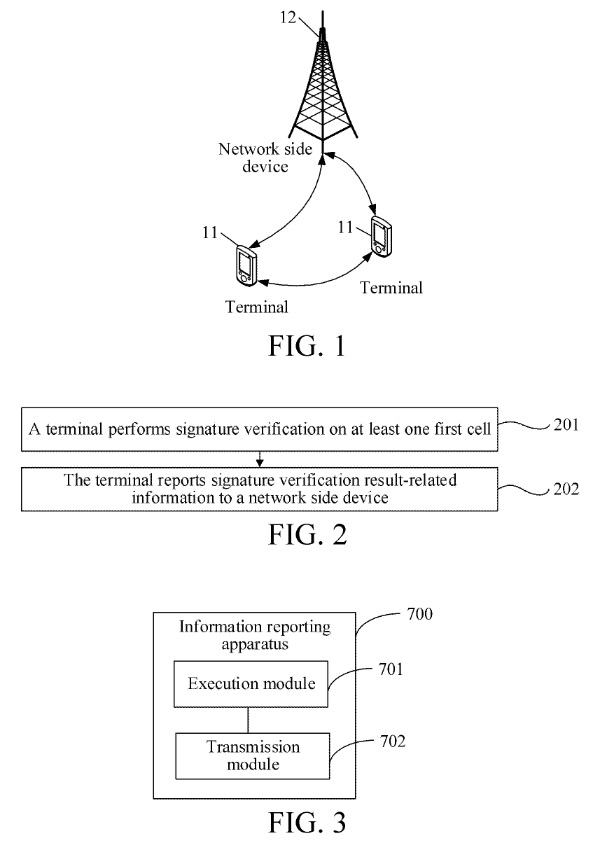

FIG. 1 is a block diagram of a wireless communication system to which embodiments of this application may be applied. The wireless communication system includes a terminal 11 and a network side device 12. The terminal 11 may be a terminal side device such as a mobile phone, a tablet computer (Tablet Personal Computer), a Laptop Computer, a notebook computer, a Personal Digital Assistant (PDA), a palm computer, a netbook, an Ultra- Mobile Personal Computer (UMPC), a Mobile Internet Device (MID), an Augmented Reality (AR) device, a Virtual Reality (VR) device, a robot, a Wearable Device, a flight vehicle, an In- Vehicle Device (VUE), a ship-borne device, a Pedestrian User Equipment (PUE), smart home (a home device with a wireless communication capability, such as a refrigerator, a television, a washing machine, or furniture), a game console, a Personal Computer (PC), a teller machine, or a self-service machine. The wearable device includes a smart watch, a smart bracelet, a smart headset, smart glasses, smart jewelry (a smart bracelet, a smart chain bracelet, a smart ring, a smart necklace, a smart ankle bangle, a smart ankle chain, and the like), a smart wristband, smart clothing, and the like. The in-vehicle device may also be referred to as an in-vehicle terminal, an in-vehicle controller, an in-vehicle module, an in-vehicle component, an in-vehicle chip, an in-vehicle unit, or the like. It should be noted that a specific type of terminal 11 is not limited in embodiments of this application. The network side device 12 may include an access network device or a core network device. The access network device may also be referred to as a Radio Access Network (RAN) device, a radio access network function, or a radio access network unit. The access network device may include a base station, a Wireless Local Area Network (WLAN) Access Point (AS), a Wireless Fidelity (Wi-Fi) node, or the like. The base station may be referred to as a NodeB (Node B, NB), an evolved NodeB (Evolved Node B, eNB), a next generation NodeB (the next generation Node B, gNB), a new radio NodeB (New Radio Node B, NR Node B), an access point, a Relay Base Station (RBS), a Serving Base Station SBS). a Base Transceiver Station (BTS), a radio base station, a radio transceiver, a Basic Service Set (BSS), an Extended Service Set (ESS), a home NodeB (home Node B, HNB), a home evolved NodeB (home evolved Node B), a Transmission Reception Point (TRP), or another appropriate term in the art. The base station is not limited to a specific technical term, as long as the same technical effect can be achieved. It should be noted that, in embodiments of this application, only a base station in an NR system is used as an example for description, and a specific type of the base station is not limited.

In the related art, a network side device sends SI, a signature key, information related to a sending time of the SI, and the like to a terminal. The terminal performs signature verification by using the information as parameters, to finally obtain a digital signature corresponding to the SI. Therefore, the terminal may determine whether the digital signature corresponding to the SI matches a digital signature corresponding to the SI broadcast by the network side device, to verify authenticity of the SI, and then determine whether to establish a connection to a base station corresponding to the SI.

However, in the foregoing manner, only the terminal can determine fake base stations after signature verification, but the network side device cannot know the fake base stations.

In the information reporting method provided in embodiments of this application, the terminal performs the signature verification on the at least one first cell, and the terminal reports the signature verification result-related information to the network side device. The signature verification result-related information obtained after the signature verification is reported to the network side device, so that the network side device can know fake base stations after obtaining the result after the signature verification.

The information reporting method provided in embodiments of this application may be performed by an information reporting apparatus. In embodiments of this application, the information reporting method provided in embodiments of this application is described by using an example in which the information reporting apparatus performs the information reporting method as a terminal.

The information reporting method provided in embodiments of this application is described below in detail through some embodiments and application scenarios thereof with reference to drawings.

FIG. 2 is a schematic flowchart of an information reporting method according to an embodiment of this application. As shown in FIG. 2, the information reporting method may include step 201 and step 202 described below.

Step 201: A terminal performs signature verification on at least one first cell.

In an example, in a case that the terminal performs signature verification in an idle state or an inactive state, the first cell is a candidate cell for cell selection or reselection.

In another example, in a case that the terminal is in a connected state, the first cell is an adjacent cell of a cell to which the terminal is currently connected.

In embodiments of this application, the terminal performs signature verification on the first cell through received signature verification information corresponding to the first cell.

Optionally, in this embodiment of this application, a process of step 201 described above includes step 201a:

Step 201a: The terminal performs the signature verification on the at least one first cell in a case that a first condition is satisfied.

The first condition includes at least one of the following:

the terminal has a signature verification capability;

the terminal is configured to perform signature verification; or

the terminal is configured with a parameter for signature verification.

In an example, the parameter for signature verification includes at least one of the following:

a security key dedicated for message broadcast;

a valid area corresponding to the security key; or

a valid time corresponding to the security key.

In an example, the security key includes a key for encryption of a broadcast message and/or a key for signing for a broadcast message.

In an example, the valid area corresponding to the security key is based on at least one or a combination of more of a tracking area (TA), an access network notification area (RNA), or a cell (Cell).

In an example, the valid time corresponding to the security key may be an absolute time (for example, effective from UTC 15:00 on Aug 22^{nd}), or may be a relative time (for example, valid after 10h since receiving, by the UE, a plurality of sets of security parameter configurations sent by a network side device).

Step 202: The terminal reports signature verification result-related information to a network side device.

In an example, in a case that the terminal is in a connected state, the terminal directly reports signature verification result-related information to the network side device after performing the signature verification.

In another example, in a case that the terminal is in an idle state or an inactive state, the terminal logs the signature verification result-related information after performing the signature verification. The terminal reports the signature verification result-related information after switching to the connected state from the idle state or the inactive state.

In embodiments of this application, the foregoing signature verification result- related information may be signature verification result-related information of a plurality of cells.

Optionally, in this embodiment of this application, the signature verification result-related information includes at least one of the following:

a signature verification result;

second indication information, where the second indication information is used to indicate that the first cell does not broadcast signature information;

cell information of the foregoing first cell; or

a location of the terminal.

In an example, the signature verification result may include a verification success or failure.

In an example, the second indication is an explicit indication, and may be expressed by using a one-bit indication. If a value is true/1, it indicates that the first cell does not broadcast signature information, and if a value is null or false/0, it indicates that the first cell broadcasts signature information. The second indication may alternatively be an implicit indication. In an example, if the signature verification result-related information does not include the signature verification result, it implicitly indicates that the first cell does not broadcast signature information.

In an example, the cell information of the first cell may include a Cell Global Identifier (CGI), a frequency in which the cell is located, a Physical Cell Identifier (PCI), and a Cell Identity.

In an example, the location of the terminal may be a location during execution of the signature information verification on the first cell. The location of the terminal may be precise location information or rough location information.

Optionally, in this embodiment of this application, the foregoing signature verification result-related information is carried by using a first Radio Resource Control (RRC) message.

In an example, that the terminal logs the signature verification result-related information includes incorporating the information into a first variable. When the terminal reports the signature verification result-related information by using the first RRC message, the terminal sets a value of content in the signature verification result-related information to a value of corresponding content in the first variable.

In an example, the first variable may further include a network registered by the terminal (for example, an RPLMN ID) and a network equivalent to the registered network.

Further, optionally, in this embodiment of this application, the information reporting method provided in embodiments of this application further includes step 301 and step 302.

Step 301: The terminal skips reporting a first measurement result of the first cell in a case that a first RRC message is a measurement report message and the terminal determines that the first cell does not broadcast signature information or the signature verification of the first cell fails.

In an example, the measurement report message may be a MeasurementReport.

In an example, the measurement report message is used to indicate a measurement result of the terminal in the connected state.

In an example, the first measurement result is related to signal quality or signal strength of the first cell.

Step 302: The terminal skips reporting the first measurement result of the first cell in a case that the first RRC message is a terminal information response message, the signature verification result-related information is carried by using a first measurement report, and the terminal determines that the first cell does not broadcast signature information or the signature verification of the first cell fails.

In an example, the terminal information response message may be a UEInformationResponse.

In an example, the first measurement report is used to provide a measurement result related to a logged Minimization of Drive Test (MDT), for example, a logMeasReport.

In an example, the first measurement result is related to signal quality or signal strength of the first cell, and is specifically, for example, MeasQuantityResults.

In an example, the foregoing signature verification result-related information includes at least one of the following:

cell information of the foregoing first cell; or

a location of the terminal.

It should be understood that the signature verification result-related information does not include a signature verification result or a measurement result of the cell, and only includes at least one of the cell information of the cell or the location of the terminal, which implicitly indicates that the signature verification of the cell fails or the cell does not broadcast signature information.

In this way, if the cell does not broadcast signature information or the signature verification of the cell fails, the terminal does not provide a report related to the minimization of drive test of the cell or some information (for example, signal quality or signal strength of the cell) in the measurement report, to implicitly indicate that the signature verification of the cell fails or the cell does not broadcast signature information, which reduces information reported by the terminal and reduces signaling overheads.

In the information reporting method provided in embodiments of this application, the terminal performs the signature verification on the at least one first cell, and the terminal reports the signature verification result-related information to the network side device. The signature verification result-related information obtained after the signature verification is reported to the network side device, so that the network side device can know fake base stations after obtaining the result after the signature verification.

Optionally, in this embodiment of this application, before step 202 "the terminal reports signature verification result-related information to a network side device" described above, the information reporting method provided in embodiments of this application further includes step 401.

Step 401: The terminal logs signature verification result-related information.

In an example, a maximum quantity of the logged signature verification result- related information is a first threshold.

In an example, the first threshold may be specified by a protocol or configured by the network side device.

In an example, if the first threshold is configured by the network side device, the configuration may be carried by using a logged measurement behavior (LoggedMeasurementConfiguration).

It should be noted that, in a case that the terminal is in the idle state or the inactive state, the terminal needs to log the signature verification result-related information after performing the signature verification. In a case that the terminal is in the connected state, the terminal may log the signature verification result-related information after performing the signature verification, or may not log the signature verification result-related information after performing the signature verification and incorporate the signature verification result-related information into the first RRC message for direct reporting to the network side device.

Optionally, in this embodiment of this application, during step 202 "the terminal reports signature verification result-related information to a network side device" described above, step 202a is included.

Step 202a: The terminal reports the signature verification result-related information based on first configuration information, or

the terminal logs the signature verification result-related information and reports the signature verification result-related information based on the first configuration information.

In an example, the first configuration information includes at least one of the following:

enabling the terminal to perform the signature verification on the first cell;

enabling the terminal to log the signature verification result-related information;

enabling the terminal to report the signature verification result-related information;

allowing the terminal to perform the signature verification on the first cell;

allowing the terminal to log the signature verification result-related information; and

allowing the terminal to report the signature verification result-related information.

In an example, the behavior of logging the signature verification result-related information performed by the terminal may be based on a protocol specification, or may be based on a network side configuration. For example, in the idle state or the inactive state, if the behavior is based on the protocol specification, that is, if the terminal satisfies the foregoing first condition, the terminal always performs logging of the signature information verification- related information in the idle state or the inactive state, that is, performs logging once the signature information verification. If the behavior is based on the network side configuration, that is, if the terminal satisfies the first condition and the network configuration allows the terminal to log the signature verification result-related information in the idle state or the inactive state, the terminal performs logging of the signature information verification-related information in the idle state or the inactive state. In an example, the network side configuration may be carried by using a LoggedMeasurementConfiguration. In an example, the first configuration information may be represented by using a one-bit indication. If a value is true/1, it indicates that the network side allows the terminal to log the signature verification result- related information in the idle state or the inactive state. If the bit does not exist or a value is false/0, it indicates that the network side does not allow the terminal to log the signature verification result-related information in the idle state or the inactive state.

It should be noted that, in a case that the terminal is in the connected state, the behavior of logging, by the terminal, the signature verification result-related information may also be based on a protocol specification, or may be based on a network side configuration. Specifically, the behavior is consistent with that when the terminal is in the idle state or the inactive state. In this way, the terminal may perform the signature verification on the first cell based on the protocol specification or the network side configuration, and log and report the signature verification result-related information.

Optionally, in this embodiment of this application, before step 202 "the terminal reports signature verification result-related information to a network side device" described above, the information reporting method provided in this application further includes step 501.

Step 501: The terminal sends first indication information.

In an example, the first indication information is used to indicate that the terminal logs the signature verification result-related information.

In an example, if the first variable logged by the terminal includes a network registered by the terminal (for example, a Registered Public Land Mobile Network (RPLMN)), the terminal sends a first indication to a network side device corresponding to the network.

In an example, the first indication may be carried by using an RRC connection complete message, an RRC connection reestablishment complete message, an RRC connection recovery complete message, or an RRC reconfiguration complete message.

Further, optionally, in this embodiment of this application, during step 202 "the terminal reports signature verification result-related information to a network side device", step 202A is included.

Step 202A: The terminal reports the signature verification result-related information to the network side device in a case that the terminal receives second information sent by the network side device.

In an example, the second information is sent by the network side device after receiving first indication information.

In an example, the second information is used to indicate that the terminal reports the signature verification result-related information, or is used to request the terminal to report the signature verification result-related information.

In an example, the terminal does not need to send the first indication when reporting the signature verification result-related information to the network side device. Instead, the terminal may directly report the signature verification result-related information to the network side device after the signature verification result-related information logged by the terminal reaches a predetermined quantity.

In an example, the predetermined quantity may be specified by a protocol, or may be configured by the network side device.

In an example, if the first variable logged by the terminal includes a network registered by the terminal (for example, an RPLMN), the terminal reports the signature verification result-related information to a network side device corresponding to the network.

It may be understood that, after receiving the signature verification result-related information reported by the terminal, the network side device can know fake base stations from the information reported by the terminal, which prevents unnecessary information leakage as a result of the terminal being connected to the fake base stations when the network side device switches the terminal to a new base station.

In this way, the terminal can report the signature verification result-related information to the network side device, so that the network side device can know fake base stations.

The information reporting method provided in embodiments of this application may be performed by an information reporting apparatus. In embodiments of this application, the information reporting apparatus provided in embodiments of this application is described by using an example in which the information reporting apparatus performs the information reporting method.

FIG. 3 is a possible schematic structural diagram of an information reporting apparatus involved in an embodiment of this application. As shown in FIG. 3, an information reporting apparatus 700 may include an execution module 701 and a transmission module 702.

The execution module 701 is configured to perform signature verification on at least one first cell. The transmission module 702 is configured to report signature verification result-related information to a network side device.

Optionally, in this embodiment of this application, in a case that a terminal performs signature verification in an idle state or an inactive state, the first cell is a candidate cell for cell selection or reselection, and in a case that the terminal is in a connected state, the first cell is an adjacent cell of a cell to which the terminal is currently connected.

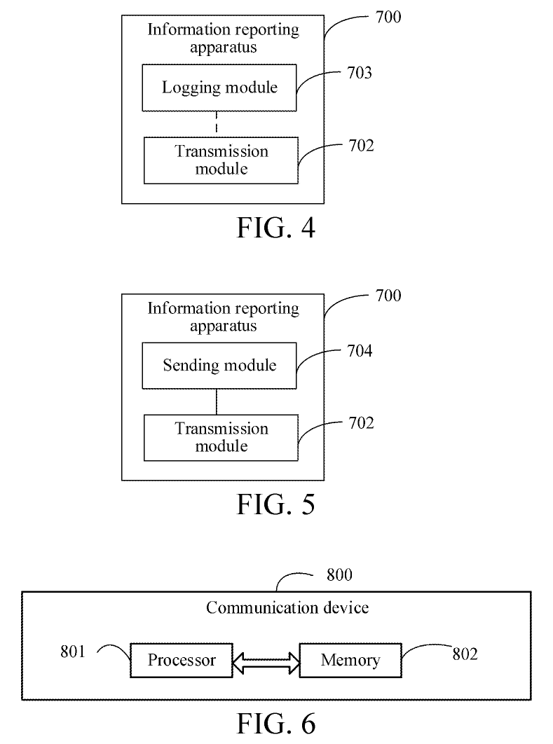

Optionally, in this embodiment of this application, with reference to FIG. 3, as shown in FIG. 4, the information reporting apparatus 700 further includes a logging module 703. The logging module 703 is configured to log the signature verification result-related information.

Optionally, in this embodiment of this application, a maximum quantity of the signature verification result-related information is a first threshold.

Optionally, in this embodiment of this application, the transmission module 702 is specifically configured to report the signature verification result-related information based on first configuration information, or log the signature verification result-related information and report the signature verification result-related information based on the first configuration information. The first configuration information includes at least one of the following: enabling the terminal to perform the signature verification on the first cell; enabling the terminal to log the signature verification result-related information; enabling the terminal to report the signature verification result-related information; allowing the terminal to perform the signature verification on the first cell; allowing the terminal to log the signature verification result-related information; or allowing the terminal to report the signature verification result-related information.

Optionally, in this embodiment of this application, the execution module 701 is specifically configured to perform the signature verification on the at least one first cell in a case that a first condition is satisfied. The first condition includes at least one of the following: the terminal has a signature verification capability; the terminal is configured to perform signature verification; or the terminal is configured with a parameter for signature verification.

Optionally, in this embodiment of this application, the foregoing parameter for signature verification includes at least one of the following: a security key dedicated for message broadcast;

a valid area corresponding to the security key; or a valid time corresponding to the security key.

Optionally, in this embodiment of this application, with reference to FIG. 3, as shown in FIG. 5, the information reporting apparatus 700 further includes a sending module 704. The sending module 704 is configured to send first indication information, where the first indication information is used to indicate that the terminal logs the signature verification result- related information. The transmission module 702 is specifically configured to report the signature verification result-related information to the network side device in a case that the module receives second information sent by the network side device, where the second information is used to instruct the terminal to report the signature verification result-related information, or is used to request the terminal to report the signature verification result-related information.

Optionally, in this embodiment of this application, the signature verification result-related information is carried by using a first RRC message.

Optionally, in this embodiment of this application, the transmission module 702 is further configured to skip reporting a first measurement result of the first cell in a case that the first RRC message is a measurement report message and the terminal determines that the first cell does not broadcast signature information or the signature verification of the first cell fails, where the first measurement result is related to signal quality or signal strength of the first cell, and the measurement report message is used to indicate a measurement result of the terminal in a connected state.

The transmission module 702 is further configured to skip the first measurement result of the first cell in a case that the first RRC message is a terminal information response message, the signature verification result-related information is carried by using a first measurement report, and the terminal determines that the first cell does not broadcast signature information or the signature verification of the first cell fails, wherein the first measurement result is related to signal quality or signal strength of the first cell, and the first measurement report is used to provide a measurement result-related to a logged MDT.

Optionally, in this embodiment of this application, the signature verification result-related information includes at least one of the following: cell information of the first cell; or a location of the terminal.

Optionally, in this embodiment of this application, the signature verification result-related information includes at least one of the following: a signature verification result; second indication information, where the second indication information is used to indicate that the first cell does not broadcast signature information; cell information of the first cell; or a location of the terminal.

In the information reporting apparatus provided in this embodiment of this application, the apparatus performs the signature verification on the at least one first cell, and the apparatus reports the signature verification result-related information to the network side device. The signature verification result-related information obtained after the signature verification is reported to the network side device, so that the network side device can know fake base stations after obtaining the result after the signature verification.

The information reporting apparatus in this embodiment of this application may be an electronic device, for example, an electronic device having an operating system, or may be a component in the electronic device, for example, an integrated circuit or a chip. The electronic device may be a terminal, or may be another device other than the terminal. In an example, the terminal may include but is not limited to the foregoing listed types of the terminal 11, and the another device may be a server, a Network Attached Storage (NAS), or the like. This is not specifically limited in this embodiment of this application.

The information reporting apparatus provided in this embodiment of this application can implement processes implemented in the method embodiment of FIG. 2, and achieve the same technical effects. To avoid repetition, details are not described herein.

As shown in FIG. 6, an embodiment of this application further provides a communication device 800, including a processor 801 and a memory 802. The memory 802 stores program or instructions executable in the processor 801. For example, when the communication device 800 is a terminal, the program or the instructions, when executed by the processor 801, implements the steps of the foregoing embodiments of the information reporting method, and can achieve the same technical effects. When the communication device 800 is a network side device, the program or the instructions, when executed by the processor 801, implements the steps of the foregoing embodiments of the information reporting method, and can achieve the same technical effect. To avoid repetition, details are not described herein again.

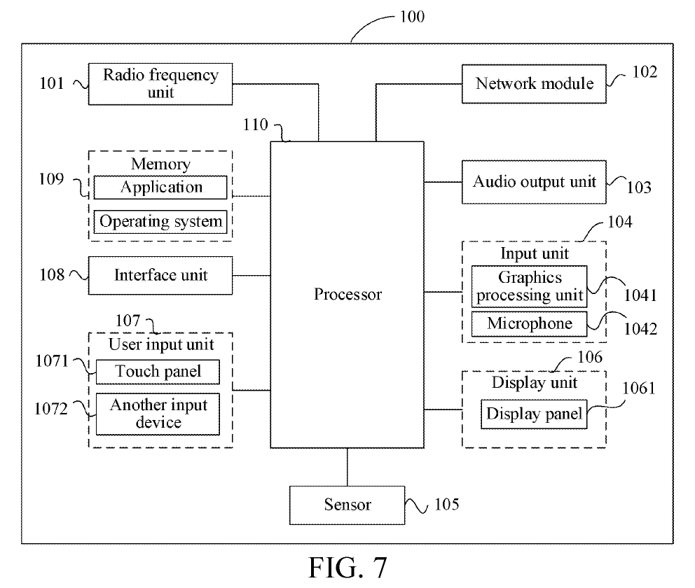

An embodiment of this application further provides a terminal, including a processor and a communication interface. The communication interface is coupled to the processor. The processor is configured to run a program or instructions, to implement the steps of the method embodiment shown in FIG. 2. The terminal embodiment corresponds to the foregoing terminal-side method embodiment. The implementation processes and implementation manners of the foregoing method embodiment are all applicable to the terminal embodiment, and can achieve the same technical effect. Specifically, FIG. 7 is a schematic diagram of a hardware structure of a terminal for implementing an embodiment of this application.

A terminal 100 includes but is not limited to at least some of components such as a radio frequency unit 101, a network module 102, an audio output unit 103, an input unit 104, a sensor 105, a display unit 106, a user input unit 107, an interface unit 108, a memory 109, and a processor 110.

A person skilled in the art may understand that the terminal 100 may further include a power supply (for example, a battery) that supplies power to the components. The power supply may be logically connected to the processor 110 through a power management system, to implement functions such as management of charging, discharging, and power consumption through the power management system. The terminal structure shown in FIG. 7 constitutes no limitation on the terminal, and the terminal may include more or fewer components than those shown in the figure, or some merged components, or different component arrangements. Details are not described herein.

It should be noted that, in this embodiment of this application, the input unit 104 may include a Graphics Processing Unit (GPU) 1041 and a microphone 1042. The graphics processing unit 1041 processes image data of a static picture or a video obtained by an image capturing apparatus (for example, a camera) in a video capturing mode or an image capturing mode. The display unit 106 may include a display panel 1061. The display panel 1061 may be configured in a form such as a liquid crystal display or an organic light-emitting diode. The user input unit 107 includes at least one of a touch panel 1071 or another input device 1072. The touch panel 1071 is also referred to as a touch screen. The touch panel 1071 may include two parts: a touch detection apparatus and a touch controller. The another input device 1072 may include but is not limited to a physical keyboard, a function button (such as a volume control button or a power button), a trackball, a mouse, and a joystick. Details are not described herein.

In this embodiment of this application, the radio frequency unit 101 receives downlink data from a network side device, and may provide the downlink data to the processor 110 for processing. In addition, the radio frequency unit 101 may send uplink data to the network side device. Generally, the radio frequency unit 101 includes but is not limited to an antenna, an amplifier, a transceiver, a coupler, a low noise amplifier, and a duplexer.

The memory 109 may be configured to store a software program or instructions and various data. The memory 109 may mainly include a first storage area for storing a program or instructions and a second storage area for storing data. The first storage area may store an operating system, an application or an instruction required for at least one function (such as a sound playback function and an image playback function), and the like. In addition, the memory 109 may include a volatile memory or a non-volatile memory. The non-volatile memory may be a Read-Only Memory (ROM), a Programmable Read-Only Memory (PROM), an Erasable Programmable Read-Only Memory (EPROM), an Electrically Erasable Programmable Read-Only Memory (EEPROM), or a flash memory. The volatile memory may be a Random Access Memory (RAM), a Static Random Access Memory (SRAM), a Dynamic Random Access Memory (DRAM), a Synchronous Dynamic Random Access Memory (SDRAM), a Double Data Rate Synchronous Dynamic Random Access Memory (DDRSDRAM), an Enhanced Synchronous Dynamic Random Access Memory (ESDRAM), a Synch Link Dynamic Random Access Memory (SLDRAM), or a Direct Rambus Random Access Memory (DRRAM). The memory 109 in this embodiment of this application includes but is not limited to these and any other suitable types of memories.

The processor 110 may include one or more processing units. Optionally, an application processor and a modem processor are integrated into the processor 110. The application processor mainly processes operations related to an operating system, a user interface, an application, and the like. The modem processor mainly processes a wireless communication signal, which, for example, may be a baseband processor. It may be understood that the modem processor may also not be integrated into the processor 110.

The processor 110 is configured to perform signature verification on at least one first cell. The radio frequency unit 101 is configured to report signature verification result- related information to a network side device.

Optionally, in this embodiment of this application, in a case that the terminal 100 performs signature verification in an idle state or an inactive state, the first cell is a candidate cell for cell selection or reselection, and in a case that the terminal 100 is in a connected state, the first cell is an adjacent cell of a cell to which the terminal 100 is currently connected.

Optionally, in this embodiment of this application, the memory 109 is configured to log the signature verification result-related information.

Optionally, in this embodiment of this application, a maximum quantity of the signature verification result-related information is a first threshold.

Optionally, in this embodiment of this application, the radio frequency unit 101 is specifically configured to report the signature verification result-related information based on first configuration information, or log the signature verification result-related information and report the signature verification result-related information based on the first configuration information. The first configuration information includes at least one of the following: enabling the terminal 100 to perform the signature verification on the first cell; enabling the terminal 100 to log the signature verification result-related information; enabling the terminal 100 to report the signature verification result-related information; allowing the terminal 100 to perform the signature verification on the first cell; allowing the terminal 100 to log the signature verification result-related information; or allowing the terminal 100 to report the signature verification result-related information.

Optionally, in this embodiment of this application, the processor 110 is specifically configured to perform the signature verification on the at least one first cell in a case that a first condition is satisfied. The first condition includes at least one of the following: the terminal 100 has a signature verification capability; the terminal 100 is configured to perform signature verification; or the terminal 100 is configured with a parameter for signature verification.

Optionally, in this embodiment of this application, the parameter for signature verification includes at least one of the following: a security key dedicated for message broadcast; a valid area corresponding to the security key; or a valid time corresponding to the security key.

Optionally, in this embodiment of this application, the radio frequency unit 101 is further configured to send first indication information, where the first indication information is used to indicate that the terminal 100 logs the signature verification result-related information. The radio frequency unit 101 is specifically configured to report the signature verification result-related information to the network side device in a case that the module receives second information sent by the network side device, where the second information is used to indicate that the terminal 100 reports the signature verification result-related information, or is used to request the terminal 100 to report the signature verification result-related information.

Optionally, in this embodiment of this application, the signature verification result-related information is carried by using a first RRC message.

Optionally, in this embodiment of this application, the radio frequency unit 101 is further configured to skip reporting a first measurement result of the first cell in a case that the first RRC message is a measurement report message and the terminal 100 determines that the first cell does not broadcast signature information or the signature verification of the first cell fails, where the first measurement result is related to signal quality or signal strength of the first cell, and the measurement report message is used to indicate a measurement result of the terminal 100 in a connected state.

The radio frequency unit 101 is further configured to skip the first measurement result of the first cell in a case that the first RRC message is a terminal 100 information response message, the signature verification result-related information is carried by using a first measurement report, and the terminal 100 determines that the first cell does not broadcast signature information or the signature verification of the first cell fails, wherein the first measurement result is related to signal quality or signal strength of the first cell, and the first measurement report is used to provide a measurement result-related to a logged MDT.

Optionally, in this embodiment of this application, the signature verification result-related information includes at least one of the following: cell information of the first cell; or a location of the terminal 100.

Optionally, in this embodiment of this application, the signature verification result-related information includes at least one of the following: a signature verification result; second indication information, where the second indication information is used to indicate that the first cell does not broadcast signature information; cell information of the first cell; or a location of the terminal 100.

In the terminal provided in this embodiment of this application, the terminal performs the signature verification on the at least one first cell, and the terminal reports the signature verification result-related information to the network side device. The signature verification result-related information obtained after the signature verification is reported to the network side device, so that the network side device can know fake base stations after obtaining the result after the signature verification.

It may be understood that for the implementation process of each implementation mentioned in this embodiment, refer to the relevant description of the information reporting method in the method embodiment, and the same or corresponding technical effect is achieved. To avoid repetition, details are not described herein.

An embodiment of this application further provides a readable storage medium. The readable storage medium stores a program or instructions. The program or the instructions, when executed by a processor, implement the processes of the foregoing embodiments of the information reporting method, and can achieve the same technical effect. To avoid repetition, details are not described herein.

The processor is a processor in the terminal described in the foregoing embodiments. The readable storage medium includes a computer-readable storage medium, such as a computer read-only memory ROM, a random access memory RAM, a magnetic disk, or an optical disk. In some examples, the readable storage medium may be a non-transient readable storage medium.

An embodiment of this application further provides a chip. The chip includes a processor and a communication interface. The communication interface is coupled to the processor. The processor is configured to run a program or instructions, to implement the processes of the foregoing embodiments of the information reporting method, and can achieve the same technical effect. To avoid repetition, details are not described herein.

It should be understood that the chip mentioned in this embodiment of this application may also be referred to as a system level chip, a system chip, a chip system, a system on chip, or the like.

An embodiment of this application further provides a computer program/program product. The computer program/program product is stored in a storage medium. The computer program/program product is executed by at least one processor to implement the processes of the foregoing embodiments of the information reporting method, and can achieve the same technical effect. To avoid repetition, details are not described herein.

It should be noted that the term "comprise", "include", or any other variant herein is intended to encompass non-exclusive inclusion, so that a process, a method, an article, or an apparatus including a series of elements not only includes those elements, but also includes another element not listed explicitly, or includes intrinsic elements for the process, the method, the article, or the apparatus. Without any further limitation, an element defined by a phrase "include one ..." does not exclude existence of an additional same element in the process, the method, the article, or the apparatus that includes the element. In addition, it should be noted that the scope of the method and the apparatus in the implementations of this application is not limited to function execution in the order shown or discussed, and may further include function execution in a substantially simultaneous manner or in the opposite order based on the functions. For example, the described method may be performed in different order from the described order, and various steps may also be added, omitted, or combined. Moreover, features described with reference to some examples may be combined in another example.

According to the descriptions of the foregoing implementations, a person skilled in the art may clearly learn that the method in the foregoing embodiments may be implemented by a computer software product with a necessary universal hardware platform, or may be implemented by hardware. The computer software product is stored in a storage medium (such as a ROM, a RAM, a magnetic disk, or an optical disk), including a plurality of instructions for causing a terminal or a network side device to perform the method in embodiments of this application.

Although embodiments of this application are described above with reference to the drawings, this application is not limited to the foregoing specific implementations. The foregoing specific implementations are illustrative rather than restrictive. With the enlightenment of this application, a person of ordinary skill in the art may make many forms of implementations without departing from the concept of this application and the protection scope of the claims. These implementations fall within the protection of this application.

What is claimed is:

1. An information reporting method, comprising:
performing, by a terminal, signature verification on at least one first cell; and
reporting, by the terminal, signature verification result-related information to a network side device.

2. The method according to claim 1, wherein in a case that the terminal performs signature verification in an idle state or an inactive state, the first cell is a candidate cell for cell selection or reselection; and
in a case that the terminal is in a connected state, the first cell is an adjacent cell of a cell to which the terminal is currently connected.

3. The method according to claim 1, wherein before the reporting, by the terminal, signature verification result-related information to a network side device, the method further comprises:
logging, by the terminal, the signature verification result-related information.

4. The method according to claim 1, wherein a maximum quantity of the signature verification result-related information is a first threshold.

5. The method according to claim 1, wherein the reporting, by the terminal, signature verification result-related information to a network side device comprises:
reporting, by the terminal, the signature verification result-related information based on first configuration information; or logging, by the terminal, the signature verification result-related information and reporting the signature verification result-related information based on the first configuration information, wherein the first configuration information comprises at least one of the following:
enabling the terminal to perform the signature verification on the first cell;
enabling the terminal to log the signature verification result-related information;
enabling the terminal to report the signature verification result-related information;
allowing the terminal to perform the signature verification on the first cell;
allowing the terminal to log the signature verification result-related information; or allowing the terminal to report the signature verification result-related information.

6. The method according to claim 1, wherein the performing, by a terminal, signature verification on at least one first cell comprises:
performing, by the terminal, the signature verification on the at least one first cell in a case that a first condition is satisfied, wherein the first condition comprises at least one of the following:
the terminal has a signature verification capability;
the terminal is configured to perform signature verification; or the terminal is configured with a parameter for signature verification.

7. The method according to claim 6, wherein the parameter for signature verification comprises at least one of the following:
a security key dedicated for message broadcast;
a valid area corresponding to the security key; or a valid time corresponding to the security key.

8. The method according to claim 6, wherein before the reporting, by the terminal, signature verification result-related information to a network side device, the method further comprises:
sending, by the terminal, first indication information, wherein the first indication information is used to indicate that the terminal logs the signature verification result-related information; and
the reporting, by the terminal, signature verification result-related information to a network side device comprises:
reporting, by the terminal, the signature verification result-related information to the network side device in a case that the terminal receives second information sent by the network side device, wherein the second information is used to instruct the terminal to report the signature verification result-related information, or is used to request the terminal to report the signature verification result-related information.

9. The method according to claim 1, wherein the signature verification result-related information is carried by using a first radio resource control RRC message.

10. The method according to claim 9, further comprising:
skipping, by the terminal, reporting a first measurement result of the first cell in a case that the first RRC message is a measurement report message and the terminal determines that the first cell does not broadcast signature information or the signature verification of the first cell fails, wherein the first measurement result is related to signal quality or signal strength of the first cell, and the measurement report message is used to indicate a measurement result of the terminal in a connected state; and
skipping, by the terminal, reporting the first measurement result of the first cell in a case
that the first RRC message is a terminal information response message, the signature verification result-related information is carried by using a first measurement report, and the terminal determines that the first cell does not broadcast signature information or the signature verification of the first cell fails, wherein the first measurement result is related to signal quality or signal strength of the first cell, and the first measurement report is used to provide a measurement result-related to a logged minimization of drive test MDT.

11. The method according to claim 10, wherein the signature verification result-related information comprises at least one of the following:
cell information of the first cell; or a location of the terminal.

12. The method according to claim 1, wherein the signature verification result-related information comprises at least one of the following:
a signature verification result;
second indication information, wherein the second indication information is used to indicate that the first cell does not broadcast signature information;
cell information of the first cell; or a location of the terminal.

13. A terminal, comprising a processor and a memory, wherein the memory stores a program or instructions executable in the processor, and the program or the instructions, when executed by the processor, implement an information reporting method, the information reporting method comprising:
performing, by a terminal, signature verification on at least one first cell; and
reporting, by the terminal, signature verification result-related information to a network side device.

14. The terminal according to claim 13, wherein in a case that the terminal performs signature verification in an idle state or an inactive state, the first cell is a candidate cell for cell selection or reselection; and
in a case that the terminal is in a connected state, the first cell is an adjacent cell of a cell to which the terminal is currently connected.

15. The terminal according to claim 13, wherein before the reporting, by the terminal, signature verification result-related information to a network side device, the method further comprises:
logging, by the terminal, the signature verification result-related information.

16. The terminal according to claim 13, wherein a maximum quantity of the signature
verification result-related information is a first threshold.

17. The terminal according to claim 13, wherein the reporting, by the terminal, signature verification result-related information to a network side device comprises:
reporting, by the terminal, the signature verification result-related information based on first configuration information; or
logging, by the terminal, the signature verification result-related information and reporting the signature verification result-related information based on the first configuration information, wherein the first configuration information comprises at least one of the following:
enabling the terminal to perform the signature verification on the first cell;
enabling the terminal to log the signature verification result-related information;
enabling the terminal to report the signature verification result-related information;
allowing the terminal to perform the signature verification on the first cell;
allowing the terminal to log the signature verification result-related information; or allowing the terminal to report the signature verification result-related information.

18. A non-transitory readable storage medium, storing a program and instructions, wherein the program or the instructions, when executed by a processor, implement an information reporting method, the information reporting method comprising:
performing, by a terminal, signature verification on at least one first cell; and
reporting, by the terminal, signature verification result-related information to a network side device.

19. A chip, comprising a processor and a communication interface, wherein the communication interface is coupled to the processor, and the processor is configured to run a program or instructions to implement the steps of the information reporting method according to claim 1.

20. A computer program product, configured to be executed by at least one processor to implement the steps of the information reporting method according to claim 1.
